(19) United States
(12) Patent Application Publication
(10) Pub. No.: US 2023/0110566 A1
(43) Pub. Date: Apr. 13, 2023

(54) METHOD FOR SYNCHRONIZATION FOR IMPROVING CONCURRENT READ PERFORMANCE OF CRITICAL SECTION IN DISTRIBUTED SHARED MEMORY AND APPARATUS USING THE SAME

(71) Applicant: ELECTRONICS AND TELECOMMUNICATIONS RESEARCH INSTITUTE, Daejeon (KR)

(72) Inventors: Baik-Song AN, Daejeon (KR); Hong-Yeon KIM, Daejeon (KR); Sang-Min LEE, Daejeon (KR); Myung-Hoon CHA, Daejeon (KR)

(21) Appl. No.: 17/938,654

(22) Filed: Oct. 6, 2022

(30) Foreign Application Priority Data
Oct. 8, 2021 (KR) 10-2021-0133768
Aug. 22, 2022 (KR) 10-2022-0104515

(51) Int. Cl. G06F 3/06

(52) U.S. Cl. CPC G06F 3/0613; G06F 3/0653; G06F 3/067

(57) ABSTRACT

Disclosed herein are a synchronization method for improving the concurrent read performance of a critical section in distributed shared memory and an apparatus for the same. The synchronization method, performed by a distributed-shared-memory management apparatus in a physical node of a multi-node system, includes checking whether a lock is held on each node based on a read-write lock having lock variables for respective nodes in a distributed shared memory environment, acquiring a lock for a read operation or a write operation in consideration of whether a lock is held on each node, and releasing the lock based on the lock variables for the respective nodes when the read operation or the write operation is terminated.

### CROSS REFERENCE TO RELATED APPLICATIONS

This application claims the benefit of Korean Patent Application No. 10-2021-0133768, filed Oct. 8, 2021, and No. 10-2022-0104515, filed Aug. 22, 2022, which are hereby incorporated by reference in their entireties into this application.

### BACKGROUND OF THE INVENTION

### 1. Technical Field

The present invention relates generally to synchronization technology for improving the concurrent read performance of a critical section in distributed shared memory, and more particularly to new read-write synchronization technology for solving a performance degradation problem caused due to attempts to simultaneously read a critical section when a read-write synchronization method is used in distributed shared memory.

### 2. Description of the Related Art

As multicore/manycore systems in which a number of CPU cores is installed are widely used, parallel programming, which improves performance using multiple cores, becomes more important and replaces technology for improving performance by merely increasing the operation clock speed of a CPU and memory.

Parallel programming, continuously developed and used in a High-Performance Computing (HPC) field, enables users to execute and control parallel programs using a parallel programming interface represented by a Message Passing Interface (MPI) or OpenMP. However, the existing HPC field mainly deals with workloads for numerical analysis and computation, which can be relatively easily parallelized, so a runtime load caused due to a task for parallelizing programs or the parallel program itself is not a great concern.

However, as manycore systems are popularized and as various and complex layers of software, including an operating system, a runtime framework, applications, and the like, run in a manycore environment, a parallelization task for efficiently using multiple cores becomes difficult and complicated.

Particularly, most systems have recently adopted Non-Uniform Memory Access (NUMA) in order to increase the system scale, and this increases the complexity of a parallelization problem. Also, a performance problem was exacerbated and has reached a serious level in a multi-node manycore system based on Distributed Shared Memory (DSM).

Distributed shared memory (DSM) is technology capable of increasing a memory volume by sharing memory units installed in multiple physical nodes through a high-speed interconnect, and is receiving attention again with the recent rapid improvement of interconnect performance and the emergence of Many-to-One Virtualization, which abstracts multiple nodes as a single large virtual machine. However, in spite of a fast interconnect, the performance of DSM is still far below that of local memory using a system bus, so a high memory performance load is caused.

In the process of parallelizing workloads, performance degradation is mostly due to a process of synchronization of access to data shared by multiple processes or threads. Such a synchronization process is performed using a lock mechanism, but, as is already known, the performance of a manycore system is rapidly degraded as a lock is frequently used for data synchronization. Particularly, when there is high contention for the use of a lock, multiple cores attempt to access a single lock variable, which increases cache-line bouncing (the process of repeatedly invalidating a cache value for each core and fetching a new value according to a cache consistency management policy) and rapidly decreases system performance.

A readers-writer lock is a synchronization mechanism in which, when only read-only requests are present, concurrent access to critical section data is allowed, but while a write request task holds a lock, concurrent access is not allowed. This is one of widely used synchronization mechanisms, because it has an effect of improving the scalability of a manycore system in a load condition in which most requests are read requests, but another performance problem may occur in distributed shared memory. When the existing readers-writer lock is used in distributed shared memory, performance degradation may be caused even when most requests are read requests. This is because multiple threads are allowed to simultaneously enter a critical section when there are only read-only requests, but the threads simultaneously try to change the value of a shared lock variable. This occurs also in a manycore system based on a single node, but distributed shared memory has lower performance than local memory, and a communication load between nodes may also be significantly increased by multiple requests to change the value of the shared lock variable. This load not only offsets performance benefits, which are acquired when most requests are read requests, but also results in overall performance degradation.

Therefore, when multiple concurrent reads are requested in distributed shared memory, it is difficult to improve performance using the existing readers-writer lock mechanism.

### Documents of Related Art

(Patent Document 1) Korean Patent Application Publication No. 10-1999-0050459, published on Jul. 5, 1999 and titled “Method and apparatus for cache coherence of multiprocessor system having distributed shared memory structure”.

### SUMMARY OF THE INVENTION

An object of the present invention is to mitigate performance degradation caused due to a shared lock variable when concurrent reads of a critical section are attempted in a distributed shared memory environment including multiple physical nodes.

Another object of the present invention is to assign a lock variable for each node and efficiently manage the same, thereby providing a new read-write synchronization mechanism capable of minimizing performance degradation caused due to sharing of a lock variable when a read lock is held.

A further object of the present invention is to improve the degree of parallelism of a system by improving the concurrent read performance of a critical section and to improve overall system performance.

In order to accomplish the above objects, a synchronization method for improving concurrent read performance of a critical section in distributed shred memory, performed by a distributed-shared-memory management apparatus in a physical node of a multi-node system, according to the present invention includes checking whether a lock is held on each node based on a read-write lock having lock variables for respective nodes in a distributed shared memory environment, acquiring a lock for a read operation or a write operation in consideration of whether the lock is held on each node, and releasing the lock based on the lock variables for the respective nodes when the read operation or the write operation is terminated.

Here, the read-write lock may have an array form including multiple entries, the number of which corresponds to the maximum number of physical nodes in the multi-node system.

Here, each of the multiple entries may include each of the lock variables for the respective nodes, and the multiple entries may be aligned so as to correspond to a minimum management unit size corresponding to the distributed shared memory environment.

Here, the values of the lock variables for the respective nodes, included in the multiple entries, are checked, whereby whether a read lock is held or whether a write lock is held may be checked.

Here, when a read lock is held on a current node, the lock for the read operation may be acquired by increasing the value of a lock variable included in an entry corresponding to the current node, among the multiple entries.

Here, when a read lock or a write lock is held on one or more nodes, release of the read lock or the write lock is waited for, after which the lock for the write operation may be acquired by changing the values of the lock variables for the respective nodes, included in the multiple entries, to a write lock acquisition state.

Here, the lock acquired for the read operation may be released by decreasing the value of a lock variable included in an entry corresponding to a current node, among the multiple entries.

Here, the lock acquired for the write operation may be released by initializing the lock variables for the respective nodes, included in the multiple entries.

Also, an apparatus for managing distributed shared memory according to an embodiment of the present invention includes a processor for checking whether a lock is held on each node based on a read-write lock having lock variables for respective nodes in a distributed shared memory environment, acquiring a lock for a read operation or a write operation in consideration of whether the lock is held on each node, and releasing the lock based on the lock variables for the respective nodes when the read operation or the write operation is terminated; and memory for storing the read-write lock.

Here, the read-write lock may have an array form including multiple entries, the number of which corresponds to the maximum number of physical nodes in a multi-node system.

Here, each of the multiple entries may include each of the lock variables for the respective nodes, and the multiple entries may be aligned so as to correspond to a minimum management unit size corresponding to the distributed shared memory environment.

Here, the processor may check the values of the lock variables for the respective nodes, included in the multiple entries, thereby checking whether a read lock is held or whether a write lock is held.

Here, when a read lock is held on a current node, the processor may acquire the lock for the read operation by increasing the value of a lock variable included in an entry corresponding to the current node, among the multiple entries.

Here, when a read lock or a write lock is held on one or more nodes, the processor may wait for release of the read lock or the write lock and then acquire the lock for the write operation by changing the values of the lock variables for the respective nodes, included in the multiple entries, to a write lock acquisition state.

Here, the processor may release the lock acquired for the read operation by decreasing the value of a lock variable included in an entry corresponding to a current node, among the multiple entries.

Here, the processor may release the lock acquired for the write operation by initializing the values of the lock variables for the respective nodes, included in the multiple entries.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a synchronization method for improving the concurrent read performance of a critical section in distributed shared memory according to an embodiment of the present invention;

FIG. 2 is a view illustrating an example of a multi-node system structure based on distributed shared memory;

FIG. 3 is a view illustrating an example of applications performing synchronization for access to distributed shared memory;

FIG. 4 is a flowchart illustrating an example of an existing read lock operation;

FIG. 5 is a flowchart illustrating an example of an existing read unlock operation;

FIG. 6 is a flowchart illustrating an example of an existing write lock operation;

FIG. 7 is a flowchart illustrating an example of an existing write unlock operation;

FIG. 8 is a view illustrating an example of an existing read-write lock;

FIG. 9 is a view illustrating an example of a read-write lock according to an embodiment of the present invention;

FIG. 10 is a flowchart illustrating an example of a read lock operation according to the present invention;

FIG. 11 is a flowchart illustrating an example of a read unlock operation according to the present invention;

FIG. 12 is a flowchart illustrating an example of a write lock operation according to the present invention;

FIG. 13 is a flowchart illustrating an example of a write unlock operation according to the present invention; and

FIG. 14 is a block diagram illustrating an apparatus for managing distributed shared memory according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

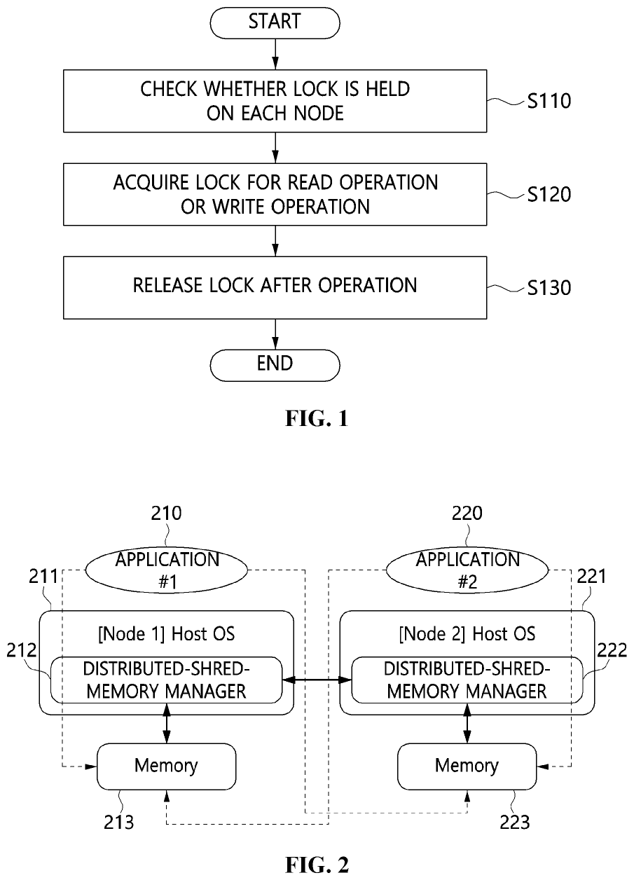

Generally, a multi-node system based on distributed shared memory may correspond to a structure such as that illustrated in FIG. 2.

Referring to FIG. 2, each physical node has local memory 213 or 223, and a host operating system 211 or 221 for each physical node may be run thereon.

Here, a distributed-shared-memory manager 212 or 222 in the host operating system manages the local memory and communicates with another distributed-shared-memory manager 222 or 212 in a remote node through an interconnect between the physical nodes, thereby accessing remote memory and using the same.

For example, application #1 210 being executed in physical node 1 may use both the local memory 213 and the remote memory 223 in physical node 2 through the distributed-shared-memory manager 212. Also, application #2 220 being executed in physical node 2 may use both the local memory 223 and the remote memory 213 in physical node 1 through the distributed-shared-memory manager 222.

As described above, memory in each node may be simultaneously accessed by processes or threads executed in different nodes, in which case a synchronization task for shared data is required.

FIG. 3 illustrates applications 310 and 320 that perform synchronization of access to distributed shared memory, and it may be assumed that application #1 310 is executed in physical node 1 and application #2 320 is executed in physical node 2, as in FIG. 2.

Here, as illustrated in FIG. 3, because all of the two applications 310 and 320 perform a read operation on memory region A, synchronization may be performed using a read lock Read_Lock, and even when contention between the two applications 310 and 320 occurs, the two applications 310 and 320 may simultaneously read memory region A without waiting.

Meanwhile, it can be seen that application #1 310 preforms a write operation on memory region B, but application #2 320 performs a read operation thereon. If application #1 310 preempts a write lock, application #2 320 is not able to access memory region B until application #1 310 releases the write lock. Likewise, if application #2 320 preempts a read lock, application #1 has to wait until application #2 320 releases the read lock.

That is, when all processes or threads perform only read operations on a shared memory region, they can simultaneously access the shared memory region, so system scalability should not be affected thereby. However, in the case of distributed shared memory, which exhibits low performance when remote memory is accessed, even when only read operations are performed, serious performance degradation may be caused.

Here, a general read-write lock provides a total of four operations corresponding to a lock and an unlock for each of a read operation and a write operation. A read-write lock may be implemented using different lock variables for a read operation and a write operation, but the present invention describes an implementation method in which all of a read operation and a write operation are managed using a single lock variable.

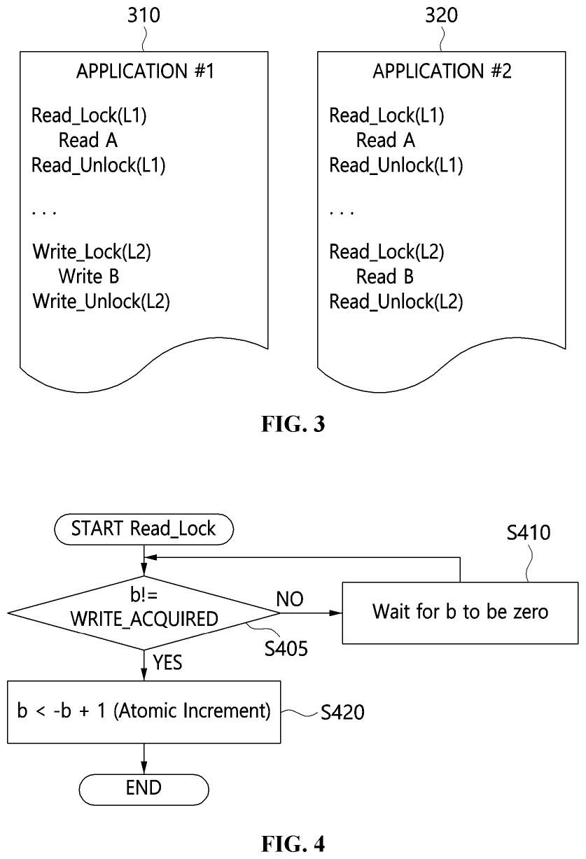

Hereinafter, a general operation process using an existing read-write lock will be described in detail with reference to FIGS. 4 to 7.

Here, variable b illustrated in FIGS. 4 to 7 may be used to indicate acquisition or release of a read lock for simultaneous access to a critical section and whether a write lock is acquired, and may be initialized to 0. Also, WRITE_ACQUIRED may be a predefined value for indicating that a write lock is acquired.

First, FIG. 4 is a flowchart illustrating an example of an existing read lock operation.

Referring to FIG. 4, when a read lock operation starts, whether the value of variable b is equal to WRITE_ACQUIRED may be determined at step S405.

If the value of variable b is equal to WRITE_ACQUIRED, this indicates that a write lock is held by another process or thread. Accordingly, after waiting for the release of the write lock at step S410, the value of variable b may be checked again.

When it is determined at step S405 that the value of variable b is not equal to WRITE_ACQUIRED, this indicates that a read-write lock is not held by any process or thread or that another reader is present, so a read lock may be acquired. Accordingly, the value of variable b is incremented by 1 at step S420, and the read lock operation may be terminated.

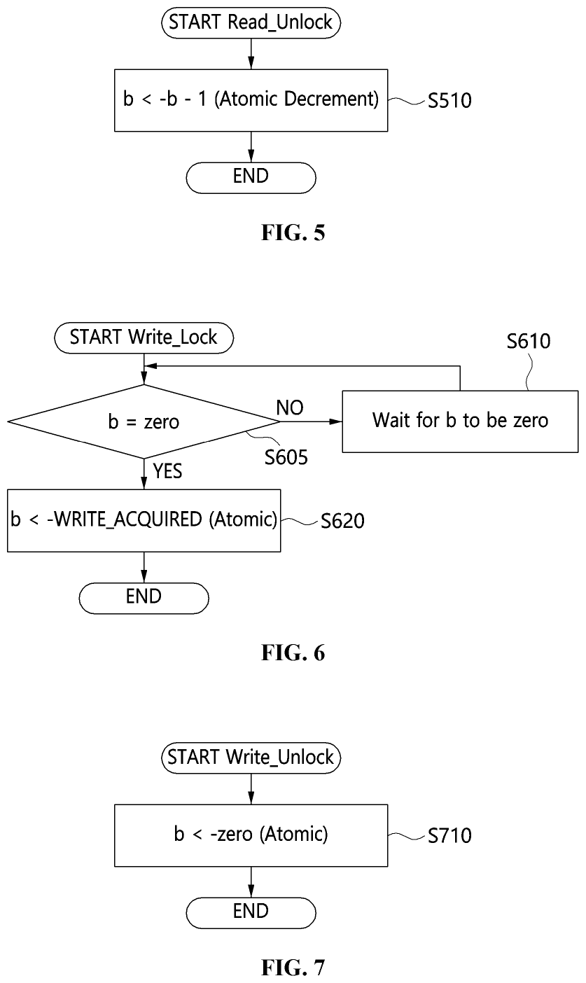

FIG. 5 is a flowchart illustrating an example of an existing read unlock operation.

Referring to FIG. 5, when a read unlock operation starts, the value of variable b is decremented by 1 at step S510, and the read unlock operation may be terminated.

FIG. 6 is a flowchart illustrating an example of an existing write lock operation.

Referring to FIG. 6, when a write lock operation starts, whether the value of variable b is 0 is determined at step S605. When the value of variable b is not 0, this indicates that a read or write lock is held by another process or thread. Accordingly, after waiting until the value of variable b becomes 0 at step S610, the value of variable b may be checked again.

When it is determined at step S605 that the value of variable b is 0, a read-write lock is not held by any process or thread, so b is set to WRITE_ACQUIRED at step S620, and the write lock operation may be terminated.

FIG. 7 is a flowchart illustrating an example of an existing write unlock operation.

Referring to FIG. 7, when a write unlock operation starts, the value of variable b is initialized to 0 at step S710, and the write unlock operation may be terminated.

Here, when the value of variable b is changed by any of the operations illustrated in FIGS. 4 to 7, an atomic operation may be used in order to guarantee consistency in consideration of the case in which multiple processes or threads simultaneously perform the operation. When all requests are read requests, concurrent entry into a critical section is allowed, but the cache line including the value of variable b may be bounced back and forth, which may cause performance degradation. This may be exacerbated in distributed shared memory, because an interconnect between nodes, which is generally used in distributed shared memory, has low performance compared to a local memory bus and because the minimum memory management unit size used in distributed shared memory is greater than the size of a cache line, which greatly increases a bouncing load.

In order to solve these problems, the present invention proposes synchronization technology for improving the concurrent read performance of a critical section in distributed shared memory using a new read-write lock.

FIG. 1 is a flowchart illustrating a synchronization method for improving the concurrent read performance of a critical section in distributed shared memory according to an embodiment of the present invention.

Referring to FIG. 1, in the synchronization method for improving the concurrent read performance of a critical section in distributed shared memory according to an embodiment of the present invention, a distributed-shared-memory management apparatus in a physical node of a multi-node system checks whether a lock is held on each node at step S110 based on a read-write lock having lock variables for respective nodes in a distributed shared memory environment.

Here, the read-write lock may be an array form including multiple entries, the number of which corresponds to the maximum number of physical nodes in the multi-node system.

Here, each of the multiple entries includes a single lock variable for each node, and the multiple entries may be aligned so as to correspond to a minimum management unit size of the distributed shared memory environment.

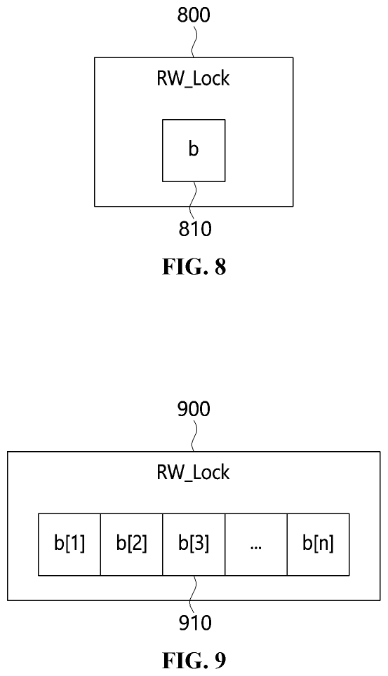

For example, the biggest difference between the existing read-write lock 800 illustrated in FIG. 8 and the read-write lock 900 proposed by the present invention is that the existing read-write lock 800 uses only a single lock variable 810, but the read-write lock 900 proposed by the present invention uses lock variables for respective nodes using a lock variable array 910 including a number of entries equal to the number of physical nodes.

According to the present invention, the lock variable may be easily implemented as an array form having entries, the number of which is equal to the maximum number of physical nodes allowed in the system.

Here, in order to prevent false sharing between the nodes, each of the entries included in the lock variable array 910 may be aligned so as to correspond to the minimum management unit size of the distributed shared memory.

For example, when the management unit size of distributed shared memory is equal to a page size (4 KB) of x86 architecture, each of the entries of the lock variable array 910 may be aligned according to the size of 4 KB.

Here, the values of the lock variables for the respective nodes, included in the multiple entries, are checked, whereby whether a read lock is held or whether a write lock is held may be checked.

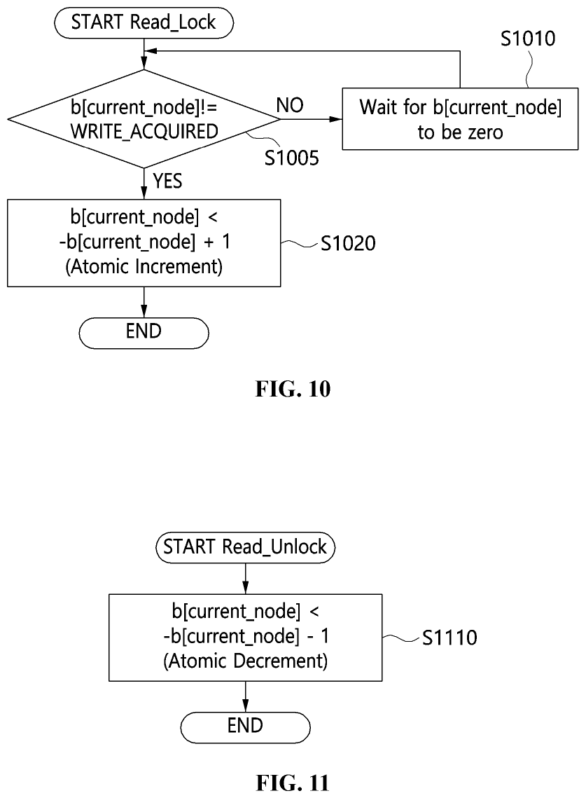

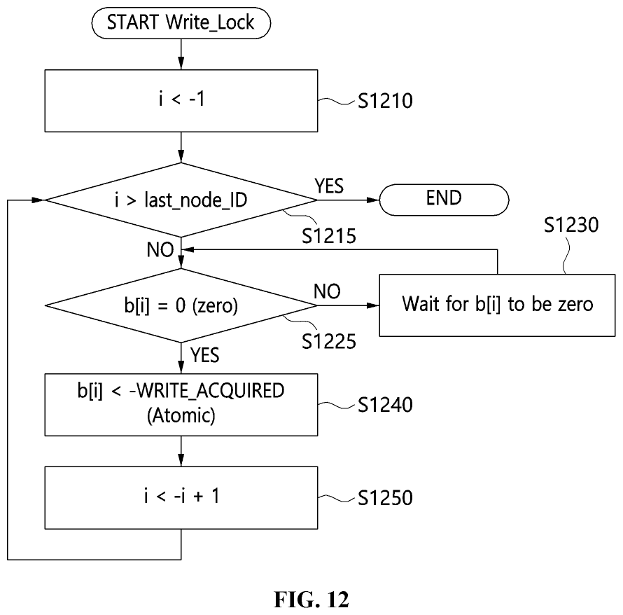

The process of checking whether the lock is held on the current node will be described in detail with reference to FIG. 10 and FIG. 12 in a description of the process of acquiring a lock.

Also, in the synchronization method for improving the concurrent read performance of a critical section in distributed shared memory according to an embodiment of the present invention, the distributed-shared-memory management apparatus in a physical node of the multi-node system acquires a lock for a read operation or a write operation in consideration of whether a lock is held on each node at step S120.

Here, when a read lock is held on the current node, the lock variable included in the entry corresponding to the current node, among the multiple entries, is incremented, whereby the lock for the read operation may be acquired.

Here, when a read lock or a write lock is held on one or more nodes, the release of the read lock or the write lock is waited for, after which the lock for a write operation may be acquired by changing the values of the lock variables for the respective nodes, included in the multiple entries, to a write lock acquisition state.

Hereinafter, a process of acquiring a lock for a read operation will be described in detail with reference to FIG. 10.

Referring to FIG. 10, in order to perform a read lock operation (Read_Lock), whether the entry value corresponding to a current node (b[current_node]) in an array corresponding to a read-write lock, that is, the value of the lock variable corresponding to the current node, is a write lock acquisition state (WRITE_ACQUIRED) may be determined at step S1005.

When it is determined at step S1005 that the value of the lock variable is a write lock acquisition state (WRITE_ACQUIRED), this indicates that the write lock is held by another process or thread. Accordingly, the release of the write lock is waited for at step S1010, and the value of b[current_node] may be checked again.

Also, when it is determined at step S1005 that the value of the lock variable is not a write lock acquisition state (WRITE_ACQUIRED), this indicates that the lock is not held by any process or thread or that another process or thread holds a read lock, so the read lock may be acquired. Accordingly, the entry value b[current_node] corresponding to the current node is incremented by 1 at step S1020, and the process of acquiring the read lock may be terminated.

Hereinafter, a process of acquiring a lock for a write operation will be described in detail with reference to FIG. 12.

Referring to FIG. 12, in order to perform a write lock operation (Write_Lock), the value of variable i is initialized to 1 at step S1210, and the value of variable i may be compared with the last physical node ID of the current system at step S1215.

Here, the last physical node ID of the current system may be the ID of the last entry included in the read-write lock. For example, referring to FIG. 9, the last physical node ID may be n.

When it is determined at step S1215 that the value of variable i is greater than the last physical node ID, this indicates that the process of updating all of the lock variables for the respective nodes, included in the read-write lock, finishes, so the process of acquiring the write lock may be terminated.

Also, when it is determined at step S1215 that the value of variable i is not greater than the last physical node ID, whether the i-th entry value in the read-write lock is 0 may be determined at step S1225.

That is, whether another process or thread holds a read lock or a write lock on the i-th physical node may be checked.

When it is determined at step S1225 that the i-th entry value is not 0, the i-th entry value may be checked again after waiting until the i-th entry value becomes 0 such that the read lock or write lock is released at step S1230.

Also, when it is determined at step S1225 that the i-th entry value is 0, this indicates that the lock is not held. Accordingly, the i-th entry value is atomically set to WRITE_ACQUIRED at step S1240, the value of variable i is incremented by 1 at step S1250, and the process returns to step S1215.

Here, the process is performed for the values of all of the entries included in the read-write lock while incrementing the value of variable i by 1, whereby the write lock may be acquired.

Also, in the synchronization method for improving the concurrent read performance of a critical section in distributed shared memory according to an embodiment of the present invention, the distributed-shared-memory management apparatus in a physical node of the multi-node system releases the lock based on the lock variables for the respective nodes at step S130 when a read operation or a write operation is terminated.

Here, the value of the lock variable included in the entry corresponding to the current node, among the multiple entries, is decreased, whereby the lock acquired for the read operation may be released.

Here, the lock variables for the respective nodes, included in the multiple entries, are initialized, whereby the lock acquired for the write operation may be released.

Hereinafter, a process by which a lock acquired for a read operation is released will be described in detail with reference to FIG. 11.

Referring to FIG. 11, in order to release a read lock (Read Unlock), the entry value corresponding to the current node (b[current node]) in the array corresponding to a read-write lock is decremented by 1 at step S1110, and the process of releasing the lock acquired for the read operation may be terminated.

Here, referring to FIG. 10 and FIG. 11, the process of acquiring a read lock (Read_Lock) and the process of releasing the read lock (Read Unlock) may be the same as the processes in the existing method of using a read-write lock, excluding that the value of the lock variable included in the entry corresponding to the unique number (ID) of the running physical node is increased and decreased by the processes of acquiring and releasing a read lock.

Here, because the entries forming the read-write lock are aligned according to the minimum memory management unit size, false sharing with other nodes is prevented, whereby memory bouncing between the physical nodes does not occur.

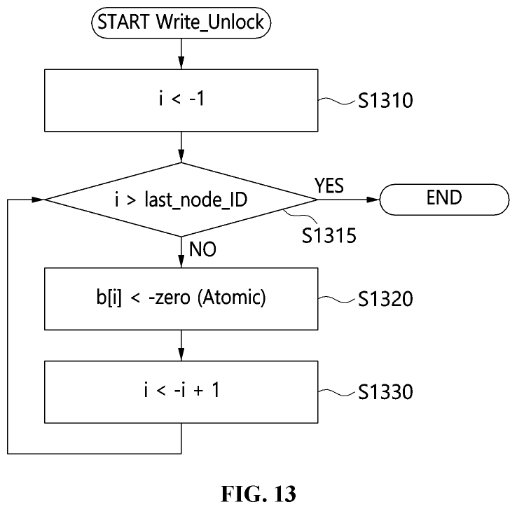

Hereinafter, the process by which a lock acquired for a write operation is released will be described in detail with reference to FIG. 13.

Referring to FIG. 13, the value of variable i is initialized to 1 at step S1310 in order to release a write lock (Write Unlock), and the value of variable i may be compared with the last physical node ID of the current system at step S1315.

Here, the last physical node ID of the current system may be the ID of the last entry included in the read-write lock. For example, referring to FIG. 9, the last physical node ID may be n.

When it is determined at step S1315 that the value of variable i is greater than the last physical node ID, this indicates that the process of updating all of the lock variables for the respective nodes, included in the read-write lock, finishes, so the process of releasing the write lock may be terminated.

Also, when it is determined at step S1315 that the value of variable i is not greater than the last physical node ID, the i-th entry value in the read-write lock is atomically initialized to 0 at step S1320, the value of variable i is incremented by 1 at step S1330, and the process is returned to step S1315.

Here, referring to FIG. 12 and FIG. 13, in the process of acquiring a write lock (Write_Lock) and the process of releasing the write lock (Write Unlock), all of the lock variables for the respective nodes, included in the read-write lock, may be updated.

Here, the order in which the entries included in the array corresponding to the read-write lock are accessed remains constant. Accordingly, when multiple processes simultaneously attempt to acquire a write lock, a deadlock, which may occur when the multiple processes arbitrarily access the write lock, may be prevented.

That is, as illustrated in FIG. 12 and FIG. 13, the entries of the read-write lock array may be sequentially accessed and processed from the first entry (1) to the last entry using variable i.

Through the above-described synchronization method for improving the concurrent read performance of a critical section in distributed shared memory, when concurrent reads of a critical section are attempted in a distributed shared memory environment including multiple physical nodes, performance degradation caused due to a shared lock variable may be mitigated.

Also, because a lock variable is assigned for each node and is efficiently managed, when a read lock is held, performance degradation caused due to sharing of a lock variable may be minimized.

Also, the degree of parallelism of a system may be improved by improving the concurrent read performance of a critical section, and overall system performance may be improved.

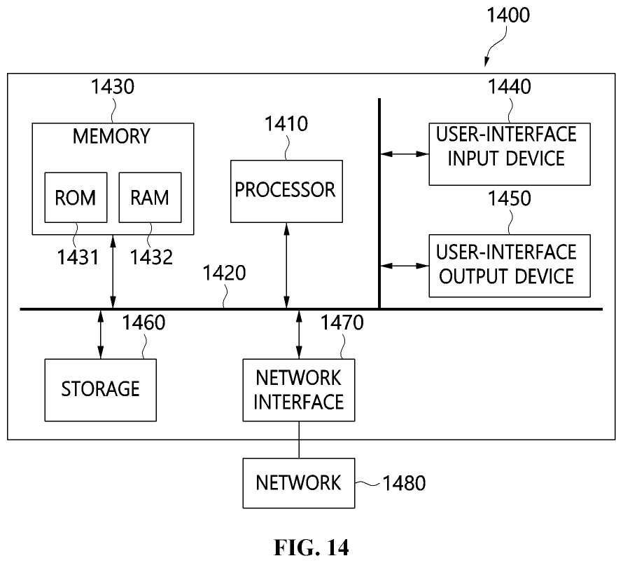

FIG. 14 is a block diagram illustrating an apparatus for managing distributed shared memory according to an embodiment of the present invention.

Referring to FIG. 14, the apparatus for managing distributed shared memory according to an embodiment of the present invention may include a processor 1410 and memory 1420.

The processor 1410 checks whether a lock is held on each node based on a read-write lock having lock variables for respective nodes in a distributed shared memory environment.

Here, the read-write lock may have an array form including multiple entries, the number of which corresponds to the maximum number of physical nodes in a multi-node system.

Here, each of the multiple entries includes each of the lock variables for the respective nodes, and the multiple entries may be aligned so as to correspond to the minimum management unit size of the distributed shared memory environment.

Here, the lock variables for the respective nodes, included in the multiple entries, are checked, whereby a read lock is held or whether a write lock is held may be checked.

Also, the processor 1410 acquires a lock for a read operation or a write operation in consideration of whether a lock is held on each node.

Here, when a read lock is held on the current node, the value of the lock variable included in the entry corresponding to the current node, among the multiple entries, is increased, whereby the lock for the read operation may be acquired.

Here, when a read lock or a write lock is held on one or more nodes, the release of the read lock or the release of the write lock is waited for, after which the lock for the write operation may be acquired by changing the values of the lock variables for the respective nodes, included in the multiple entries, to a write lock acquisition state.

When a read operation or a write operation is terminated, the processor 1410 releases the lock based on the lock variables for the respective nodes.

Here, the value of the lock variable included in the entry corresponding to the current node, among the multiple entries, is decreased, whereby the lock acquired for the read operation may be released.

Here, the values of the lock variables for the respective nodes, included in the multiple entries, are initialized, whereby the lock acquired for the write operation may be released.

Also, the memory 1420 stores the read-write lock.

Using the above-described apparatus for managing distributed shared memory, when concurrent reads of a critical section are attempted in a distributed shared memory environment including multiple physical nodes, performance degradation caused due to a shared lock variable may be mitigated.

Also, because a lock variable is assigned for each node and is efficiently managed, when a read lock is held, performance degradation caused due to sharing of a lock variable may be minimized.

Also, the degree of parallelism of a system may be improved by improving the concurrent read performance of a critical section, and overall system performance may be improved.

According to the present invention, when concurrent reads of a critical section are attempted in a distributed shared memory environment including multiple physical nodes, performance degradation caused due to a shared lock variable may be mitigated.

Also, the present invention assigns a lock variable for each node and efficiently manages the same, thereby providing a new read-write synchronization mechanism capable of minimizing performance degradation caused due to sharing of a lock variable when a read lock is held.

Also, the present invention may improve the degree of parallelism of a system by improving the concurrent read performance of a critical section, and may improve overall system performance.

As described above, the synchronization method for improving the concurrent read performance of a critical section in distributed shared memory and an apparatus for the same according to the present invention are not limitedly applied to the configurations and operations of the above-described embodiments, but all or some of the embodiments may be selectively combined and configured, so the embodiments may be modified in various ways.

What is claimed is:

1. A synchronization method for improving concurrent read performance of a critical section in distributed shred memory, performed by a distributed-shared-memory management apparatus in a physical node of a multi-node system, comprising:
checking whether a lock is held on each node based on a read-write lock having lock variables for respective nodes in a distributed shared memory environment;
acquiring a lock for a read operation or a write operation in consideration of whether the lock is held on each node; and
releasing the lock based on the lock variables for the respective nodes when the read operation or the write operation is terminated.

2. The synchronization method of claim 1, wherein the read-write lock has an array form including multiple entries, a number of which corresponds to a maximum number of physical nodes in the multi-node system.

3. The synchronization method of claim 2, wherein each of the multiple entries includes each of the lock variables for the respective nodes, and the multiple entries are aligned so as to correspond to a minimum management unit size corresponding to the distributed shared memory environment.

4. The synchronization method of claim 3, wherein values of the lock variables for the respective nodes, included in the multiple entries, are checked, whereby whether a read lock is held or whether a write lock is held is checked.

5. The synchronization method of claim 4, wherein, when a read lock is held on a current node, the lock for the read operation is acquired by increasing a value of a lock variable included in an entry corresponding to the current node, among the multiple entries.

6. The synchronization method of claim 4, wherein, when a read lock or a write lock is held on one or more nodes, release of the read lock or the write lock is waited for, after which the lock for the write operation is acquired by changing the values of the lock variables for the respective nodes, included in the multiple entries, to a write lock acquisition state.

7. The synchronization method of claim 3, wherein the lock acquired for the read operation is released by decreasing a value of a lock variable included in an entry corresponding to a current node, among the multiple entries.

8. The synchronization method of claim 3, wherein the lock acquired for the write operation is released by initializing values of the lock variables for the respective nodes, included in the multiple entries.

9. An apparatus for managing distributed shared memory, comprising:
a processor for checking whether a lock is held on each node based on a read-write lock having lock variables for respective nodes in a distributed shared memory environment, acquiring a lock for a read operation or a write operation in consideration of whether the lock is held on each node, and releasing the lock based on the lock variables for the respective nodes when the read operation or the write operation is terminated; and
memory for storing the read-write lock.

10. The apparatus of claim 9, wherein the read-write lock has an array form including multiple entries, a number of which corresponds to a maximum number of physical nodes in a multi-node system.

11. The apparatus of claim 10, wherein each of the multiple entries includes each of the lock variables for the respective nodes, and the multiple entries are aligned so as to correspond to a minimum management unit size corresponding to the distributed shared memory environment.

12. The apparatus of claim 11, wherein the processor checks values of the lock variables for the respective nodes, included in the multiple entries, thereby checking whether a read lock is held or whether a write lock is held.

13. The apparatus of claim 12, wherein, when a read lock is held on a current node, the processor acquires the lock for the read operation by increasing a value of a lock variable included in an entry corresponding to the current node, among the multiple entries.

14. The apparatus of claim 12, wherein, when a read lock or a write lock is held on one or more nodes, the processor waits for release of the read lock or the write lock and then acquires the lock for the write operation by changing the values of the lock variables for the respective nodes, included in the multiple entries, to a write lock acquisition state.

15. The apparatus of claim 11, wherein the processor releases the lock acquired for the read operation by decreasing a value of a lock variable included in an entry corresponding to a current node, among the multiple entries.

16. The apparatus of claim 11, wherein the processor releases the lock acquired for the write operation by initializing values of the lock variables for the respective nodes, included in the multiple entries.
